(19) United States
(12) Patent Application Publication
(10) Pub. No.: US 2021/0283870 A1
(43) Pub. Date: Sep. 16, 2021

(54) TIRE PLUG APPARATUS AND METHOD OF USE

(71) Applicant: Gentian Gjinaj, White Plains, NY (US)

(72) Inventor: Gentian Gjinaj, White Plains, NY (US)

(21) Appl. No.: 17/197,405

(22) Filed: Mar. 10, 2021

Related U.S. Application Data
(60) Provisional application No. 62/988,105, filed on Mar. 11, 2020.

(51) Int. Cl. B29C 73/08

(52) U.S. Cl. CPC B29C 73/08

(57) ABSTRACT

A tire plug apparatus for repairing a hole in a tubeless tire on a rim using a tire plug is provided. The tire plug apparatus includes: a body configured to receive an insertion tip for inserting the tire plug into the hole; an adjustable stabilizing arm or strap configured to attach to the body and adjust to contact the tire or rim in order to stabilize the body with respect to the hole; and a motor within or otherwise attached to the body. The motor is configured to: supply an insertion force to insert the received insertion tip into the hole in order to insert the tire plug into the hole using the insertion tip while the body remains stabilized with respect to the hole; and supply an extraction force to extract the inserted insertion tip from the hole while leaving the inserted tire plug in the hole.

### RELATED APPLICATION

The present application claims priority to U.S. Provisional Application Ser. No. 62/988,105 filed Mar. 11, 2020 which is incorporated by reference in its entirety.

### FIELD OF THE DISCLOSURE

The present disclosure relates to vehicle tire repair in general, and, more specifically, to a tire plug apparatus and method of using the tire plug apparatus.

### BACKGROUND OF THE DISCLOSURE

A pressurized, pneumatic, or inflatable tubeless tire is used to facilitate vehicle motion by serving as a point of contact with the ground over which the vehicle is moving. The tire includes an outer tread frequently made primarily of rubber or a synthetic compound similar to rubber. However, during the vehicular movement, the tire may encounter a penetrating foreign object such as a nail or a screw that forms a hole, puncture, or other opening (referred to as “hole” throughout) in the tread of the tire. The tire is tubeless, that is, it lacks an inner tube, such that the tire tread and rim directly contain the pressurized air that fills the tire. As a result, the tire may leak air (or other pressurized gas) through the hole, leading to unintended consequences such as a flat tire, rim damage, and vehicle damage, to name a few.

Such a hole can frequently be fixed by using a tire plug, such as a string-type tire plug. However, existing techniques of plugging such a hole using a tire plug are mostly manual, and the quality of the repairs can vary widely. More specifically, inserting the tire plug thorough the hole or puncture can be quite difficult, such that most techniques employ lubricant or other liquid (like adhesive) that plays a lubricating role in part. This lubricant can cause later issues, which can compromise the integrity of the repair. In addition, most existing techniques result in an even larger (albeit plugged) hole being formed, which can lead to further damage being formed in the tire (such as in the interior of the tire. Accordingly, such repairs are often considered temporary until more proper repairs can be effected.

It is in regard to these and other problems in the art that the present disclosure is directed to provide a technical solution for an effective powered tire plug apparatus and method of using the tire plug apparatus that results in a safer and more robust repair for a tubeless tire having a small puncture in the tread, and without the existing tire plug requirements such as lubrication and hole enlargement.

### SUMMARY OF THE DISCLOSURE

According to an embodiment, a tire plug apparatus for repairing a hole in a tubeless tire on a rim using a tire plug is provided. The tire plug apparatus comprises: a body configured to receive an insertion tip for inserting the tire plug into the hole; an adjustable stabilizing arm or strap configured to attach to the body and adjust to contact the tire or rim in order to stabilize the body with respect to the hole; and a motor within or otherwise attached to the body and configured to supply an insertion force to insert the received insertion tip into the hole in order to insert the tire plug into the hole using the insertion tip while the body remains stabilized with respect to the hole, and supply an extraction force to extract the inserted insertion tip from the hole while leaving the inserted tire plug in the hole.

In an embodiment, the body comprises a grip from which to hold the tire plug apparatus in one hand.

In an embodiment, the grip comprises a trigger to activate the insertion force and the extraction force using one or more digits of the one hand.

In an embodiment, the tire plug comprises a string plug, the insertion tip has a threading member for threading the string plug prior to inserting the string plug into the hole, and the threading member is open on one end to disengage the threaded string plug from the inserted insertion tip during the extraction of the insertion tip from the hole.

In an embodiment, the motor is further configured to receive electrical power to supply the insertion force and the extraction force.

In an embodiment, the body is further configured to receive a battery to provide the received electrical power to the motor.

According to another embodiment, a method for repairing a hole in a tubeless tire on a rim using a tire plug apparatus is provided. The tire plug apparatus comprises a body, an insertion tip attached to the body and holding a tire plug, an adjustable stabilizing arm or strap attached to the body, and a motor within or otherwise attached to the body. The method comprises: adjusting the stabilizing arm or strap to contact the tire or rim and stabilize the body with respect to the hole; supplying, using the motor, an insertion force to insert the attached insertion tip and held tire plug into the hole while the body remains stabilized with respect to the hole; and supplying, using the motor, an extraction force to extract the inserted insertion tip from the hole while leaving the inserted tire plug in the hole.

In an embodiment, the body comprises a grip, and the method further comprises holding the tire plug apparatus in one hand using the grip.

In an embodiment, the grip comprises a trigger, and the method further comprises activating the insertion force and the retraction force using one or more digits of the one hand.

In an embodiment, the tire plug comprises a string plug, the insertion tip has a threading member open on one end, and the method further comprises threading the string plug using the threading member, and disengaging the inserted string plug from the inserted insertion tip during the extraction of the insertion tip using the open end of the threading member.

In an embodiment, the method further comprises receiving electrical power by the motor to supply the insertion force and the extraction force.

In an embodiment, the method further comprises attaching a battery to the body to provide the received electrical power to the motor.

In an embodiment, the method further comprises trimming exposed ends of the inserted tire plug after extracting the insertion tip from the hole.

According to yet another embodiment, a tire plug apparatus for repairing a hole in a tubeless tire on a rim using a tire plug is provided. The tire plug apparatus comprises: an insertion tip configured to insert the tire plug into the hole; a body configured to receive the insertion tip; an adjustable stabilizing member attached to the body and configured to adjust to contact the tire or rim in order to stabilize the body with respect to the hole; and a motor within or otherwise attached to the body. The mother is configured to supply an insertion force to insert the received insertion tip into the hole in order to insert the tire plug into the hole using the insertion tip while the body remains stabilized with respect to the hole, and supply an extraction force while the body remains stabilized with respect to the hole in order to extract the inserted insertion tip from the hole while leaving the inserted tire plug in the hole.

In an embodiment, the adjustable stabilizing member comprises an arm or strap.

In an embodiment, the body comprises a grip from which to hold the tire plug apparatus in one hand.

In an embodiment, the grip comprises a trigger to activate the insertion force and the extraction force using one or more digits of the one hand.

In an embodiment, the tire plug comprises a string plug, the insertion tip has a threading member for threading the string plug prior to inserting the string plug into the hole, and the threading member is open on one end to disengage the threaded string plug from the inserted insertion tip during the extraction of the insertion tip from the hole.

In an embodiment, the motor is further configured to receive electrical power to supply the insertion force and the extraction force.

In an embodiment, the body is further configured to receive a battery to provide the received electrical power to the motor.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 is an oblique view of an example tire plug apparatus, according to an embodiment.

FIG. 2 is a side view of the tire plug apparatus of FIG. 1.

FIG. 3 is a side view of the insertion tip of the tire plug apparatus of FIG. 1.

FIG. 4 is a top view of the tire plug apparatus of FIG. 1.

FIG. 5 is a front view of the tire plug apparatus of FIG. 1.

FIG. 6 is a computer-aided design (CAD) depiction of a view of the tire plug apparatus of FIG. 1.

FIG. 7 is a computer-aided design (CAD) depiction of a view of the tire plug apparatus of FIG. 1.

FIG. 8 is a computer-aided design (CAD) depiction of a view of the tire plug apparatus of FIG. 1.

FIG. 9 is a computer-aided design (CAD) depiction of a view of the tire plug apparatus of FIG. 1.

FIG. 10 is a computer-aided design (CAD) depiction of a view of the tire plug apparatus of FIG. 1.

FIG. 11 is a computer-aided design (CAD) depiction of a view of the tire plug apparatus of FIG. 1.

FIG. 12 is a computer-aided design (CAD) depiction of a view of the tire plug apparatus of FIG. 1.

FIG. 13 is a computer-aided design (CAD) depiction of a view of the tire plug apparatus of FIG. 1.

FIG. 14 is a flow chart of an example method for repairing a small hole in a tubeless tire on a rim using a tire plug apparatus, such as the tire plug apparatus of FIG. 1, according to an embodiment.

FIG. 15 is an oblique view of an example tire plug apparatus stabilized with respect to a hole in a tire, according to an embodiment.

It is noted that the drawings are illustrative and not necessarily to scale.

### DETAILED DESCRIPTION OF CERTAIN EMBODIMENTS OF THE DISCLOSURE

Example embodiments of the present disclosure are directed to a motorized tire plug apparatus and method of using the tire plug apparatus. In one such embodiment, the tire plug apparatus is a power tool that has an insertion tip that can be threaded with a string-type tire plug. In addition, the tire plug apparatus uses a motor housed within a body of the apparatus to insert or drive the threaded tire plug into a hole in the tread of a tubeless tire being repaired. The tire plug apparatus also has an extendable stabilizing arm or strap that connects to the body and contacts the tire or rim in order to stabilize the body with respect to the tire hole. After insertion, the motor extracts the insertion tip from the hole, leaving the tire plug to fill the hole and repair the tire. It should be noted that additional steps, such as removing any foreign object from the hole (before inserting the tire plug) or cutting any exposed ends of the tire plug after filling the hole, may also be performed as appropriate.

As discussed earlier, tires are subject to penetrating foreign objects (e.g., nails, screws, and other sharp objects) during normal vehicular use. These punctures can be fixed in tubeless tires using tire plugs through a manual process of extracting the foreign object, enlarging (e.g., reaming out) the hole, and plugging the enlarged hole with a tire plug to seal the hole, often using lubricant to improve the process of inserting the tire plug. However, the repair quality of this process can be inconsistent. In addition, the process leads to larger holes in the tires, and possible further interior damage to the tire (e.g., to the radial belts within the tire). Further, increasing the hole size increases the likelihood of water entering the interior of the tire through the plugged hole during normal operation of the tire. Using lubricant or adhesive can lead to complications such as failed or faulted repairs, or dislodging or leaking of the tire plugs. As such, these types of repairs are more for exigent circumstances and short-term solutions, such as quickly fixing a flat tire while traveling and without convenient access to a tire repair facility.

Accordingly, in an example embodiment, a tire plug apparatus for repairing a hole in a tubeless tire on a rim using a tire plug is provided. The tire plug apparatus includes: a body configured to receive an insertion tip for inserting the tire plug into the hole; an adjustable stabilizing arm or strap configured to attach to the body and adjust to contact the tire or rim in order to stabilize the body with respect to the hole; and a motor within or otherwise attached to the body. The motor is configured to: supply an insertion force to insert the received insertion tip into the hole in order to insert the tire plug into the hole using the insertion tip while the body remains stabilized with respect to the hole; and supply an extraction force to extract the inserted insertion tip from the hole while leaving the inserted tire plug in the hole.

The tire plug apparatus produces consistently high quality tire-plug repairs and without enlarging the existing holes or further damaging the interiors of the tubeless tires, and without needing lubrication or adhesive. As such, the tire plug apparatus can be used to effect longer term or more permanent repairs in the tires than possible with existing techniques. However, any puncture of a tire risks further complications, such as interior damage to the tire belts or future water leaks into the tire through the plugged hole. Nonetheless, the techniques discussed herein lessen or minimize these complications, providing greater usability and more safety than currently obtainable through existing techniques.

It should be noted that the holes that are to be repaired have a certain size. In certain embodiments, the size of the hole are ⅜ of an inch or less, such as 0 to ⅛ of an inch, ⅛ of an inch to ¼ of an inch, or ¼ of an inch to ⅜ of an inch. Here, size can refer to, for example, a length of the hole, a diameter of the hole, a largest diameter of the hole, or some similar definition of one-dimensional magnitude to describe the extent of the hole. In certain embodiments, the holes are not circular. The size of the hole could vary depending on factors such as the tire technology, tire-plug technology, or industry standards. In addition, the holes are in the tread of the tire, such as the portion of the tire contacting the ground. This is also referred to as the crown area of the tire, which can be approximately an inch to an inch and a half from the sides or sidewalls of the tire.

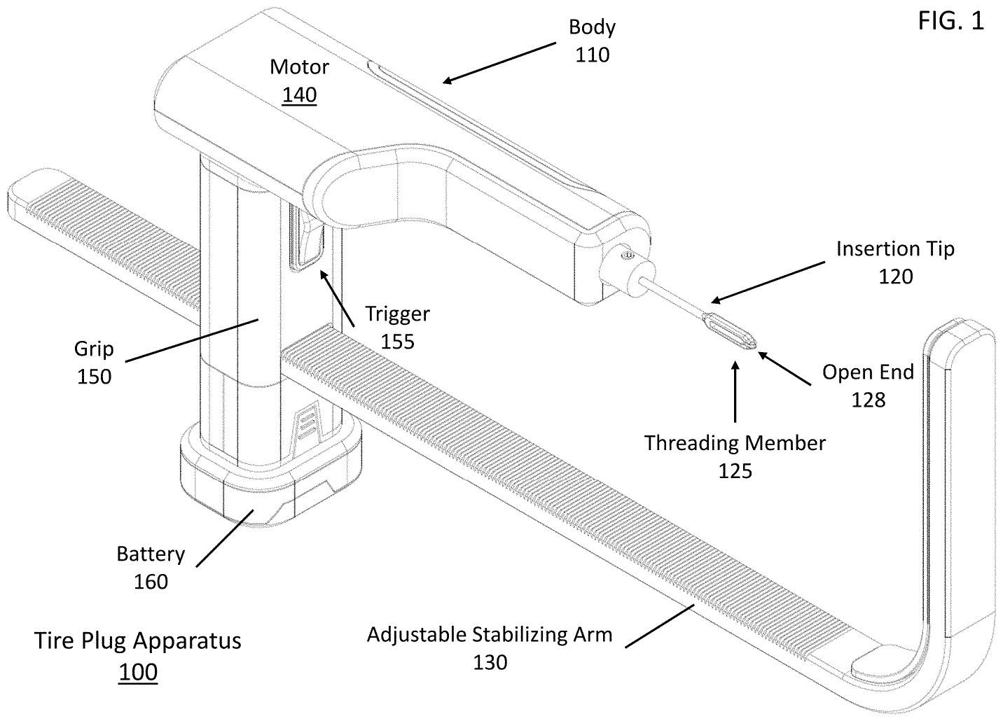

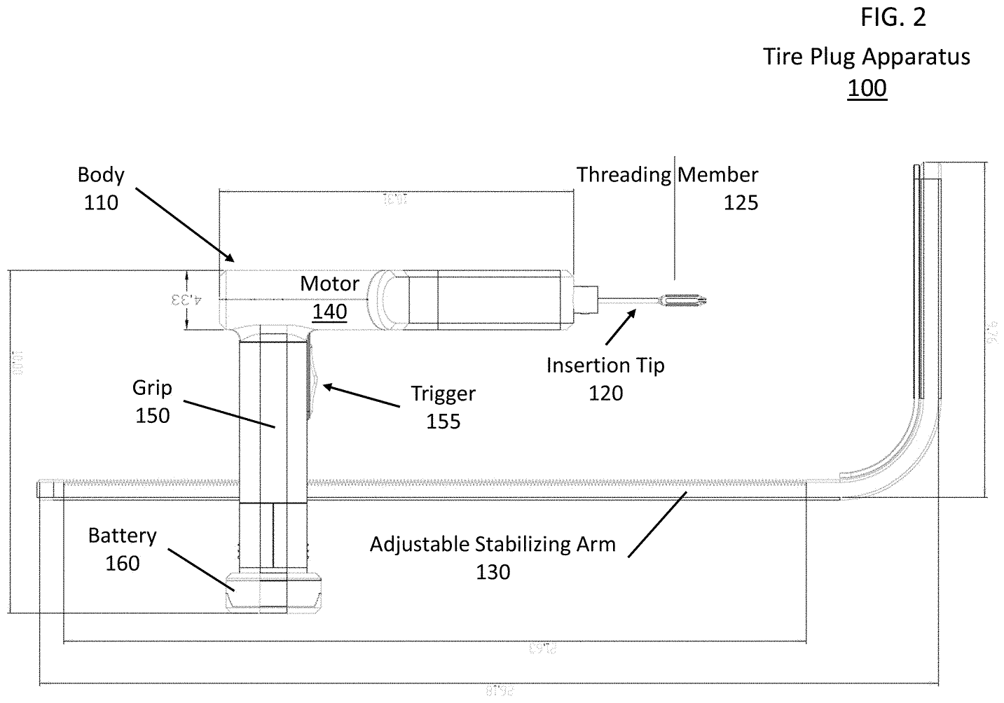

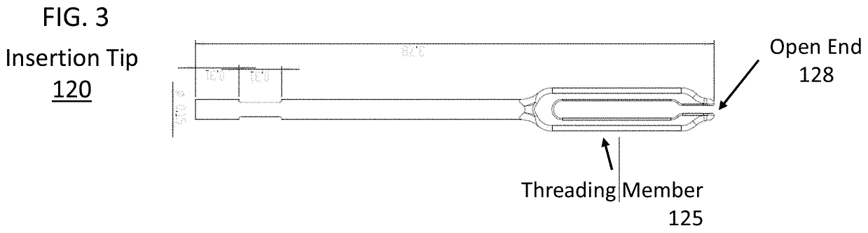

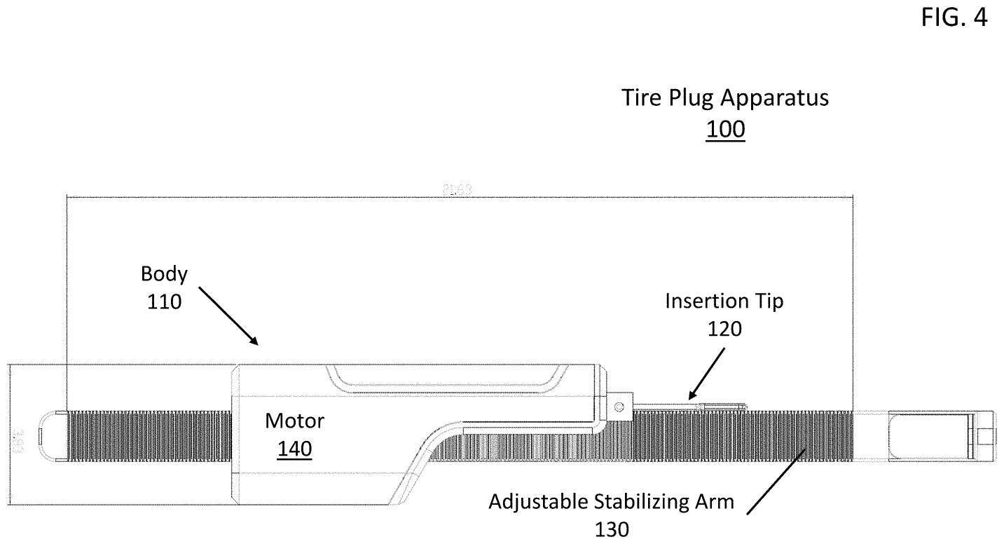

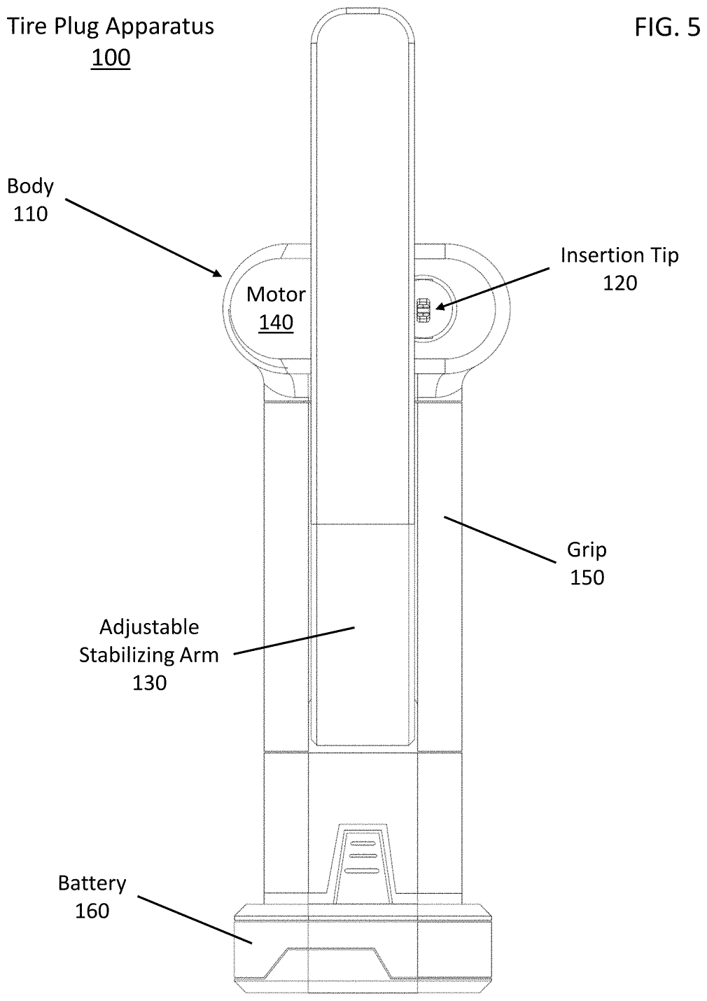

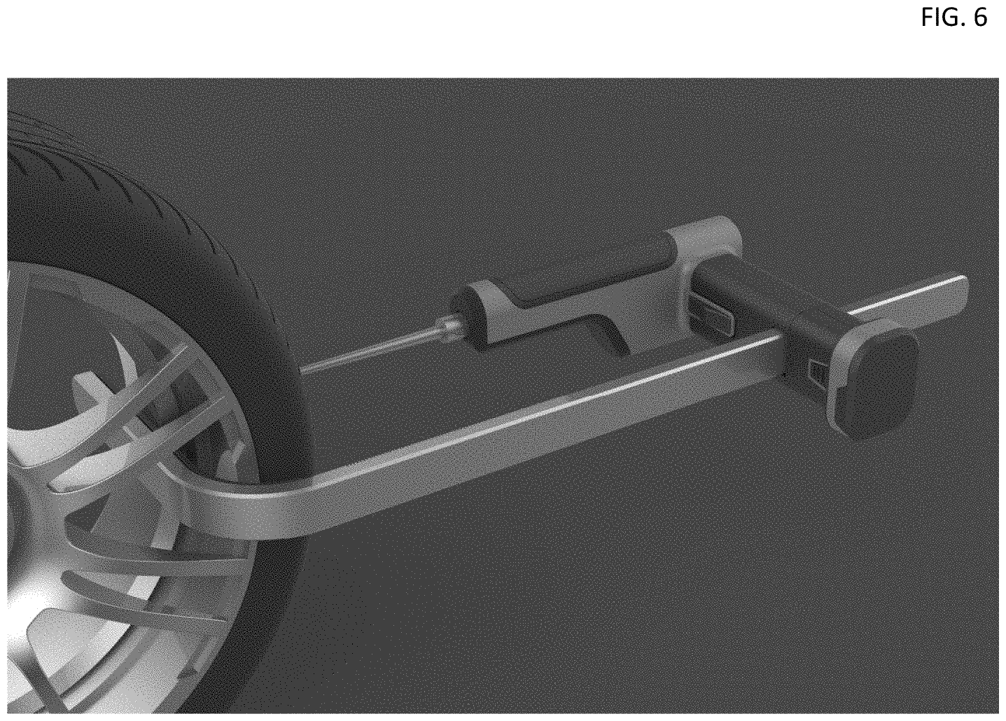

FIG. 1 is an oblique view of an example tire plug apparatus 100, according to an embodiment. FIG. 2 is a side view of the tire plug apparatus 100 of FIG. 1. FIG. 3 is a side view of the insertion tip 120 of the tire plug apparatus 100 of FIG. 1. FIG. 4 is a top view of the tire plug apparatus 100 of FIG. 1. FIG. 5 is a front view of the tire plug apparatus 100 of FIG. 1. In addition, FIGS. 6-13 are computer-aided design (CAD) depictions of the tire plug apparatus 100 of FIG. 1, in various uses, orientations, and points of focus. The tire plug apparatus 100 of FIGS. 1-13 is but one example embodiment of the present disclosure. Example dimensions (in inches) of the tire plug apparatus 100 appear in FIGS. 2-4. Other embodiments and dimensions are possible, as apparent or described throughout.

Referring to FIGS. 1-5 in particular, the pipeline apparatus 100 includes a body 110 for holding, containing, or otherwise attaching the remaining components of the apparatus 100. The body 110 may be made of a durable material, such as metal, plastic, composite, or the like (or a combination of these). The body 110 is configured to hold a removable or replaceable insertion tip 120 for threading a string-type tire plug used for repairing holes (e.g., nail holes, screw holes, and the like) in tubeless tires. The insertion tip 120 is made of a durable material such as metal designed to withstand powered insertion into and powered extraction from holes in rubber tire treads. The tire treads may also include other materials, such as metal bands or belts, or further stiffening or protection components. The insertion tip 120 includes a threading member 125 for holding the tire plug. The insertion tip 120 (and more specifically, the threading member 125) has an open end 128 (e.g., far end of the threading member 125) for allowing the threaded tire plug to separate from the threading member 125 when the insertion tip is pulled away (extracted) in a direction opposite that of insertion. During the insertion into the tire hole, the threaded tire plug stays attached to the threading member 125 at the opposite end (e.g., near end) of the threading member 125.

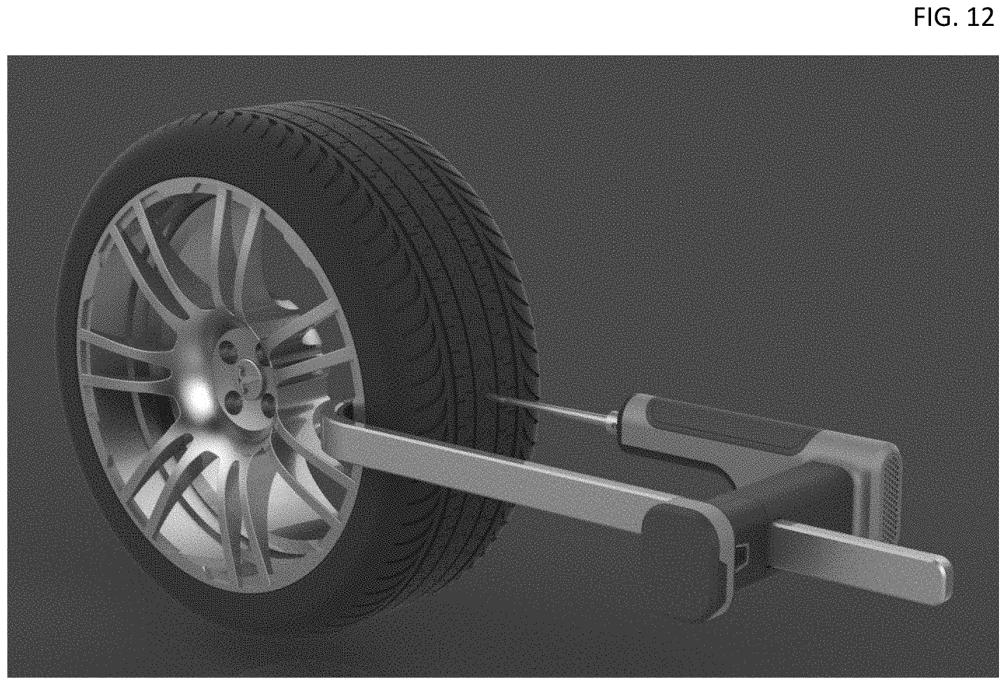

The tire plug apparatus 100 further includes an adjustable stabilizing arm 130 for stabilizing the apparatus 100 with respect to the tire hole. See, for example, FIGS. 6 and 12 for illustrations of example such stabilizations using the rim of the tire being repaired to stabilize the apparatus 100. The stabilization is accomplished by adjusting (e.g., sliding or extending, then locking, possibly power-assisted with the help of a motor) the stabilizing arm 130 with respect to the attached body 110 to contact a stable surface. The stable surface can be, for example, the tire, rim, or other fixed component of the wheel or vehicle to which the tire is attached. This takes place while the tire is attached to the rim. This contact allows the insertion tip 120 to be inserted into the tire hole without causing displacement of the body 110 with respect to the tire. The adjustable stabilizing arm 130 may be made of a durable material such as metal capable of withstanding the force of contacting the tire and stabilizing the tire plug apparatus 100 for numerous repair cycles.

The tire plug apparatus 100 further includes a motor 140 (e.g., electric motor, pneumatic motor, or the like) for supplying the driving (e.g., insertion and extraction) force needed to operate the insertion tip 120 of the apparatus 100. In some embodiments, the motor 140 (or other motor) may also adjust (extend or retract) the adjustable stabilizing arm 130. The tire plug apparatus 100 is configured to receive corresponding power to operate the motor 140, such as electric power (e.g., alternating current such as a plug or direct current such as a battery) or pneumatic power (e.g., compressed air, such as from a compressor). The tire plug apparatus 100 further includes a grip 150 for allowing handheld operation (such as in one hand). For example, the grip 150 may allow the apparatus to be stabilized during the tire repair using the adjustable stabilizing arm 130 and the tire or rim. While held by hand, the force (insertion and extraction) of the motor 140 can be activated using a corresponding trigger 155. For instance, the trigger 155 can be operated by one or more digits (fingers or thumb) of the hand holding the body 110 via the grip 150. The grip 150 (and trigger 155) may be made of a durable material such as metal, plastic, rubber, composite, or the like.

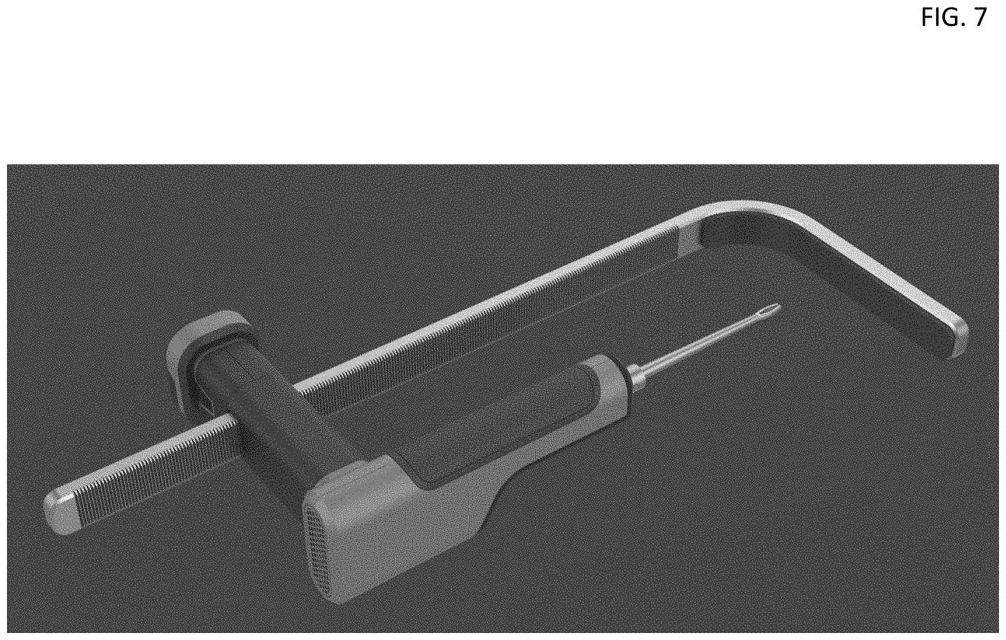

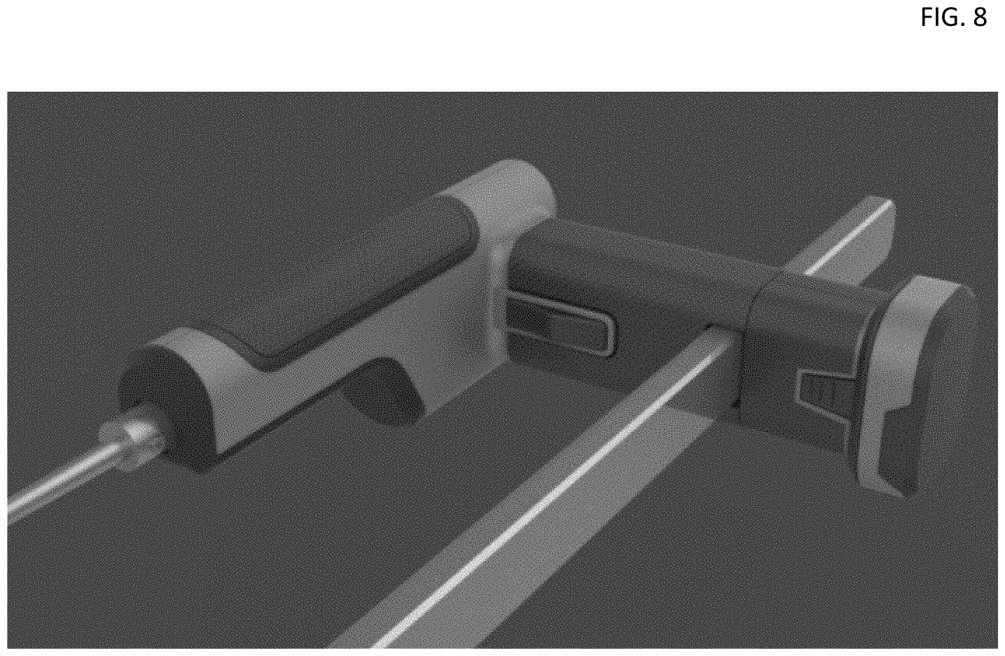

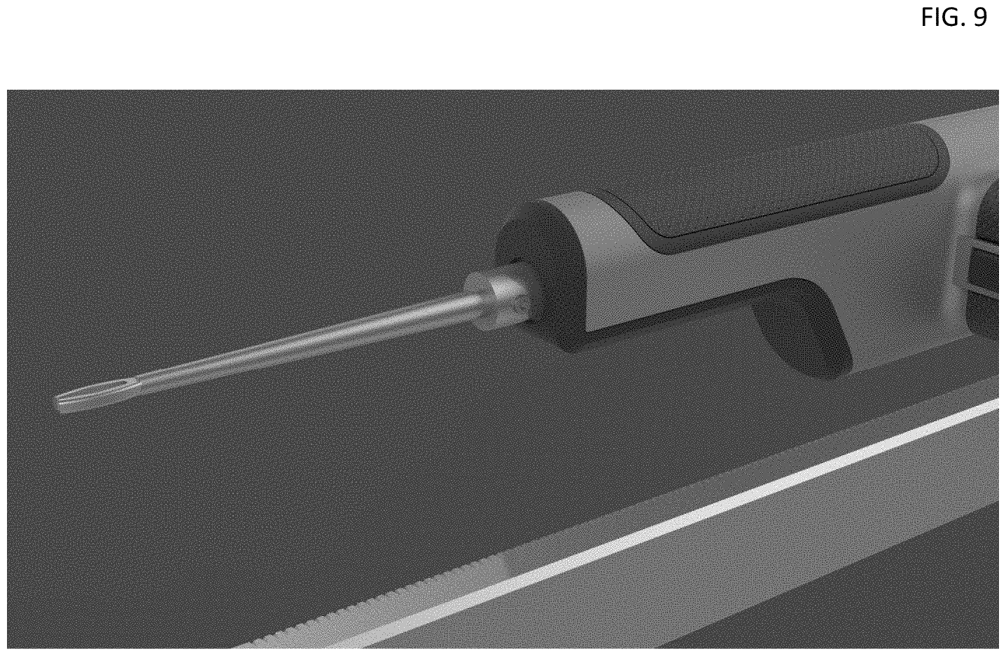

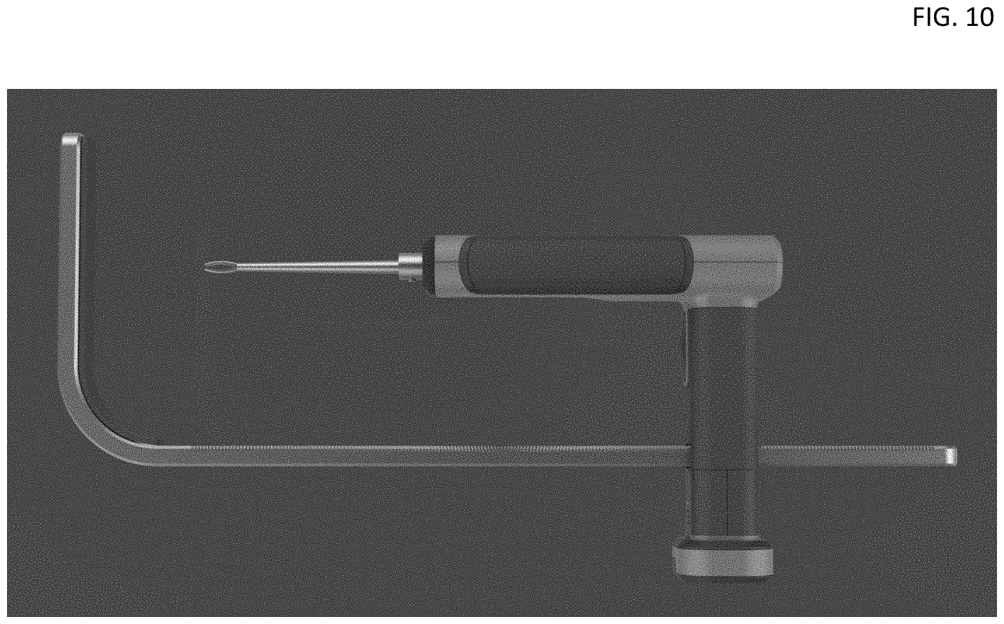

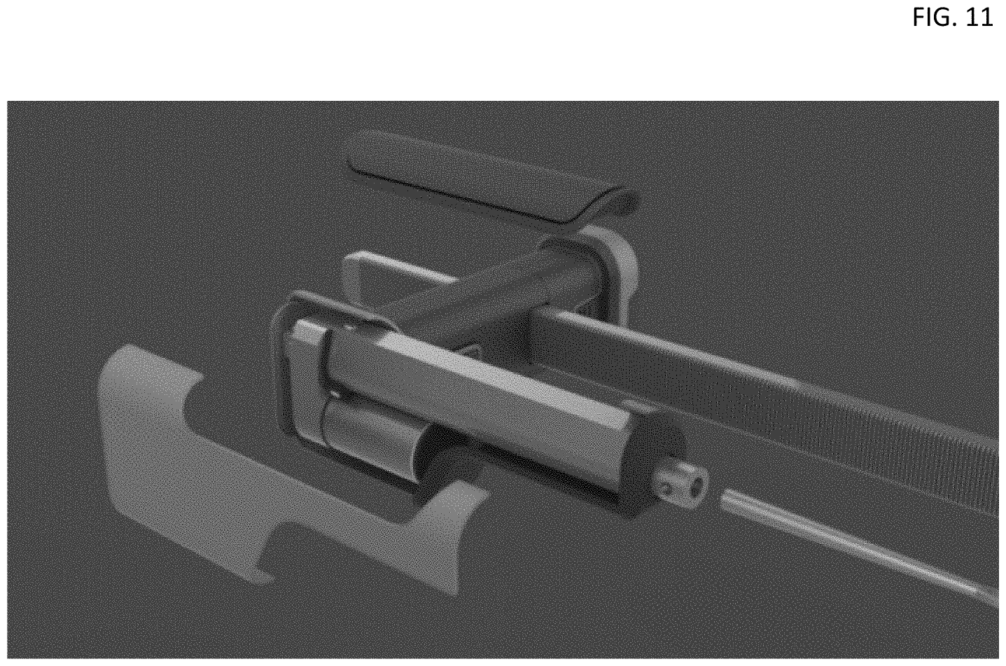

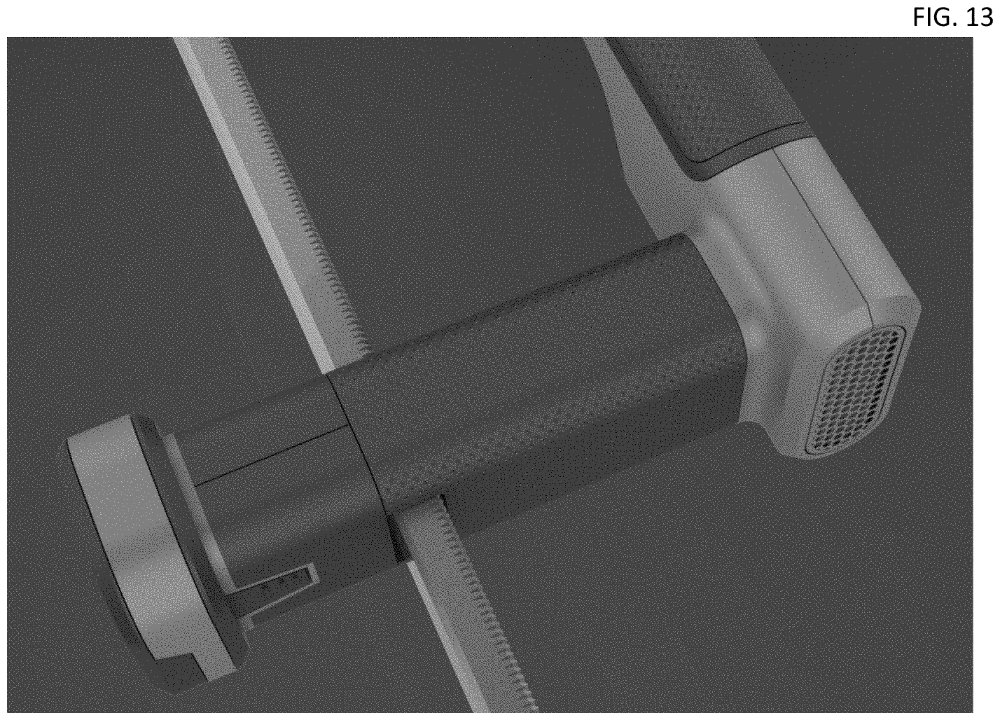

In the tire plug apparatus 100, power is supplied by an attached battery 160 (such as a rechargeable battery). However, in other embodiments, power may be supplied by a power cord, compressed air hose, or the like. FIGS. 7 and 10 illustrate the tire plug apparatus 100 from oblique and side orientations, respectively. FIG. 8 illustrates the body 110, including the grip 150 and trigger 155. FIG. 9 illustrates the insertion tip 120 as attached to the apparatus 100. FIG. 11 illustrates an exploded view of the body 110, showing an example motor 140. FIG. 13 illustrates a side view of the grip 150, highlighting the connection of the adjustable stabilizing bar 130 to the body 110.

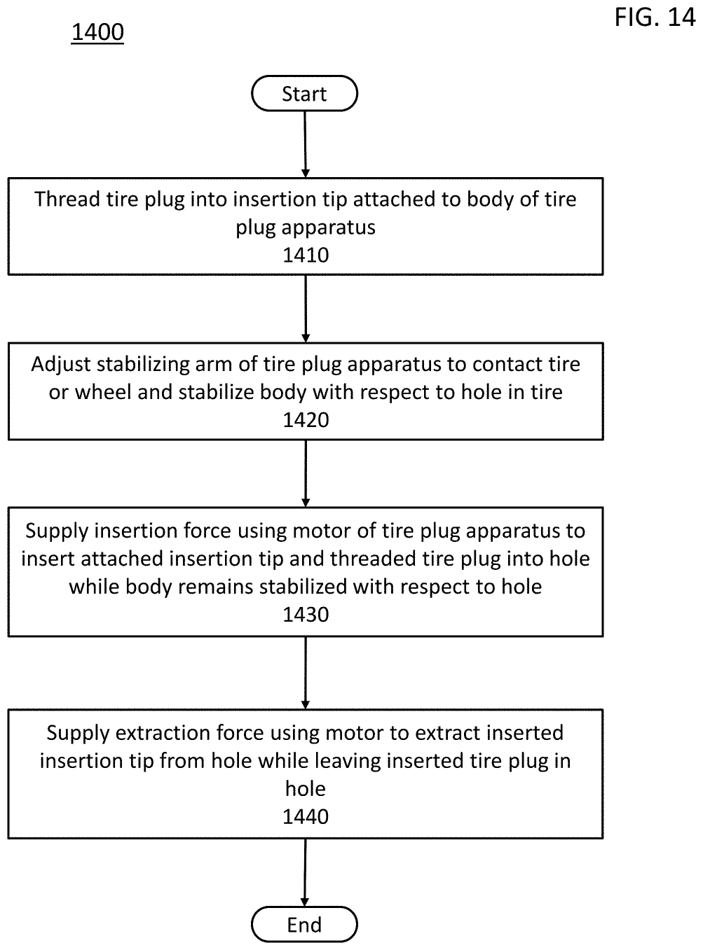

FIG. 14 is a flow chart of an example method 1400 for repairing a hole in a tubeless tire on a rim using a tire plug apparatus, such as the tire plug apparatus 100 of FIG. 1, according to an embodiment. Some or all of the method 1400 can be performed using components and techniques illustrated in FIGS. 1-13. The tire plug apparatus includes a body (such as body 110), an insertion tip (such as insertion tip 120) attached to the body and holding a tire plug (such as a string-type tire plug), an adjustable stabilizing arm or strap (such as adjustable stabilizing arm 130 or adjustable stabilizing strap 235) attached to the body, and a motor (such as motor 140) within or otherwise attached to the body.

The method 1400 includes the step of threading 1410 the tire plug into the insertion tip (such as through threading member 125). In addition, the method 1400 includes the step of adjusting 1420 the stabilizing arm or strap to contact the tire or rim and stabilize the body with respect to the hole. The method 1400 further includes the step of supplying 1430, using the motor, an insertion force to insert the attached insertion tip and threaded tire plug into the hole while the body remains stabilized with respect to the hole. In addition, the method 1400 includes the step of supplying 1440, using the motor, an extraction force to extract the inserted insertion tip from the hole while leaving the inserted tire plug in the hole. The tire plug fills the hole and repairs the tire. Exposed ends of the tire plug can be cut (to the level of the tread) to complete the repair.

In some embodiments, the method 1400 further includes removing any foreign object (such as a nail or screw) from the hole prior to inserting the tire plug. In some embodiments, the body includes a grip (such as grip 150) from which to hold the tire plug apparatus in one hand. In some such embodiments, the grip includes a trigger (such as trigger 155), and the method 1400 further includes activating the insertion force and the retraction force using one or more digits of the one hand. In some embodiments, the tire plug is a string plug, the insertion tip has a threading member (such as threading member 125) open on one end (such as open end 128), and the method further includes threading the string plug using the threading member, and disengaging the inserted string plug from the inserted insertion tip during the extraction of the insertion tip using the open end of the threading member. In some embodiments, the method 1400 further includes receiving electrical power by the motor to supply the insertion force and the extraction force. In some such embodiments, this electric power supply includes attaching a battery to the body to provide the received electrical power to the motor.

The methods described herein may be performed in part or in full by software or firmware in machine readable form on a tangible (e.g., non-transitory) storage medium. For example, the software or firmware may be in the form of a computer program including computer program code adapted to perform some or all of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

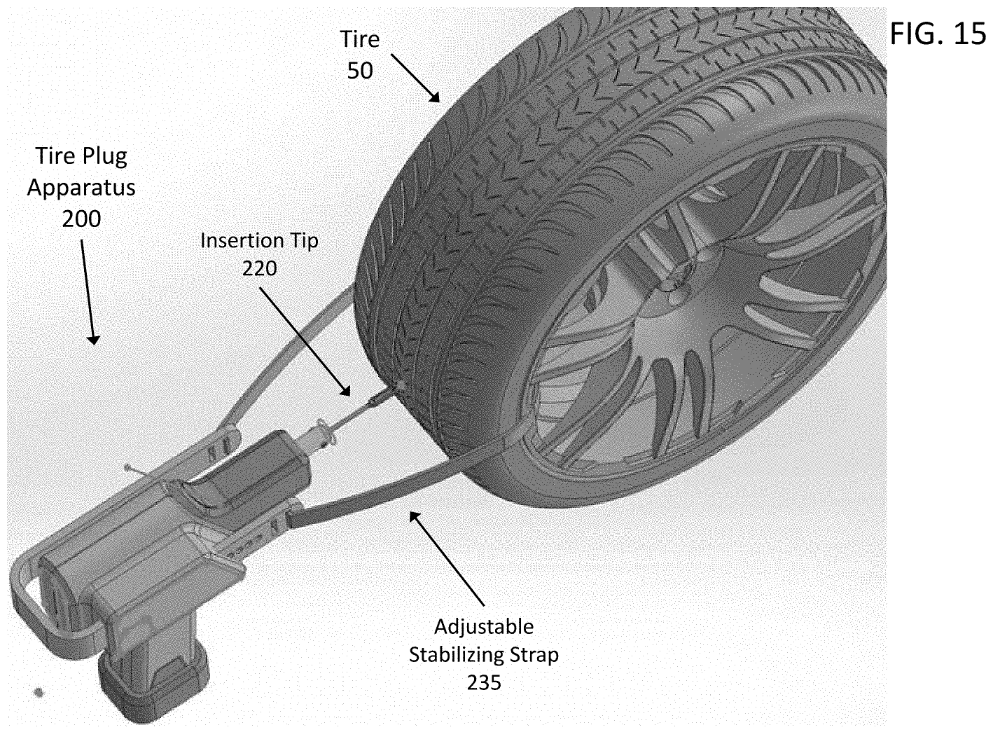

FIG. 15 is an oblique view of an example tire plug apparatus 200 stabilized with respect to a hole in a tire 50, according to an embodiment. The tire plug apparatus 200 shares numerous features in common with the tire plug apparatus 100, such as insertion tip 220, which is positioned next to the hole in the tire 50. As such, the description of the tire plug apparatus 200 will focus primarily on the distinctions with respect to the tire plug apparatus 100.

The tire plug apparatus 200 includes an adjustable stabilizing strap 235 for stabilizing the apparatus 200 with respect to the tire hole. The stabilization is accomplished by, for example, threading the strap 235 through the rim of the tire 50, attaching both ends of the strap 235 to the apparatus 200, and adjusting (e.g., reducing any slack, possibly power-assisted with the help of a motor) the stabilizing strap 235 with respect to the attached apparatus 200. This stability allows the insertion tip 220 to be inserted into the hole of the tire 50 without causing displacement of the body of the apparatus 200 with respect to the tire 50. The adjustable stabilizing strap 235 may be made of a durable flexible material such as rubber, leather, plastic, composite, metal chain, or other suitable material capable of withstanding the force of securing and stabilizing the tire 50 with respect to the apparatus 200 for numerous repair cycles.

The tire plug apparatus 200 further includes a motor similar to the motor 140 described above. In some embodiments, the motor also adjusts (reduces or increases) the slack in the adjustable stabilizing strap 235.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the scope of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The foregoing description of the specific embodiments will so fully reveal the general nature of the disclosure that others can, by applying knowledge within the skill of the relevant art(s) (including the contents of the documents cited and incorporated by reference herein), readily modify and/or adapt for various applications such specific embodiments, without undue experimentation, without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of examples, and not limitation. It would be apparent to one skilled in the relevant art(s) that various changes in form and detail could be made therein without departing from the spirit and scope of the disclosure. Thus, the present disclosure should not be limited by any of the above-described exemplary embodiments but should be defined only in accordance with the following claims and their equivalents.

All references cited herein are incorporated herein by reference in their entirety and for all purposes to the same extent as if each individual publication or patent or patent application was specifically and individually indicated to be incorporated by reference in its entirety for all purposes.

What is claimed is:

1. A tire plug apparatus for repairing a hole in a tubeless tire on a rim using a tire plug, the tire plug apparatus comprising:
a body configured to receive an insertion tip for inserting the tire plug into the hole;
an adjustable stabilizing arm or strap configured to attach to the body and adjust to contact the tire or rim in order to stabilize the body with respect to the hole; and
a motor within or otherwise attached to the body and configured to
supply an insertion force to insert the received insertion tip into the hole in order to insert the tire plug into the hole using the insertion tip while the body remains stabilized with respect to the hole, and
supply an extraction force to extract the inserted insertion tip from the hole while leaving the inserted tire plug in the hole.

2. The tire plug apparatus of claim 1, wherein the body comprises a grip from which to hold the tire plug apparatus in one hand.

3. The tire plug apparatus of claim 2, wherein the grip comprises a trigger to activate the insertion force and the extraction force using one or more digits of the one hand.

4. The tire plug apparatus of claim 1, wherein the tire plug comprises a string plug, the insertion tip has a threading member for threading the string plug prior to inserting the string plug into the hole, and the threading member is open on one end to disengage the threaded string plug from the inserted insertion tip during the extraction of the insertion tip from the hole.

5. The tire plug apparatus of claim 1, wherein the motor is further configured to receive electrical power to supply the insertion force and the extraction force.

6. The tire plug apparatus of claim 5, wherein the body is further configured to receive a battery to provide the received electrical power to the motor.

7. A method for repairing a hole in a tubeless tire on a rim using a tire plug apparatus, the tire plug apparatus comprising a body, an insertion tip attached to the body and holding a tire plug, an adjustable stabilizing arm or strap attached to the body, and a motor within or otherwise attached to the body, the method comprising:
adjusting the stabilizing arm or strap to contact the tire or rim and stabilize the body with respect to the hole;
supplying, using the motor, an insertion force to insert the attached insertion tip and held tire plug into the hole while the body remains stabilized with respect to the hole; and
supplying, using the motor, an extraction force to extract the inserted insertion tip from the hole while leaving the inserted tire plug in the hole.

8. The method of claim 7, wherein the body comprises a grip, and the method further comprises holding the tire plug apparatus in one hand using the grip.

9. The method of claim 8, wherein the grip comprises a trigger, and the method further comprises activating the insertion force and the retraction force using one or more digits of the one hand.

10. The method of claim 7, wherein the tire plug comprises a string plug, the insertion tip has a threading member open on one end, and the method further comprises threading the string plug using the threading member, and disengaging the inserted string plug from the inserted insertion tip during the extraction of the insertion tip using the open end of the threading member.

11. The method of claim 7, further comprising receiving electrical power by the motor to supply the insertion force and the extraction force.

12. The method of claim 11, further comprising attaching a battery to the body to provide the received electrical power to the motor.

13. The method of claim 7, further comprising trimming exposed ends of the inserted tire plug after extracting the insertion tip from the hole.

14. A tire plug apparatus for repairing a hole in a tubeless tire on a rim using a tire plug, the tire plug apparatus comprising:
an insertion tip configured to insert the tire plug into the hole;
a body configured to receive the insertion tip;
an adjustable stabilizing member attached to the body and configured to adjust to contact the tire or rim in order to stabilize the body with respect to the hole; and
a motor within or otherwise attached to the body and configured to
supply an insertion force to insert the received insertion tip into the hole in order to insert the tire plug into the hole using the insertion tip while the body remains stabilized with respect to the hole, and
supply an extraction force while the body remains stabilized with respect to the hole in order to extract the inserted insertion tip from the hole while leaving the inserted tire plug in the hole.

15. The tire plug apparatus of claim 14, wherein the adjustable stabilizing member comprises an arm or strap.

16. The tire plug apparatus of claim 14, wherein the body comprises a grip from which to hold the tire plug apparatus in one hand.

17. The tire plug apparatus of claim 16, wherein the grip comprises a trigger to activate the insertion force and the extraction force using one or more digits of the one hand.

18. The tire plug apparatus of claim 14, wherein the tire plug comprises a string plug, the insertion tip has a threading member for threading the string plug prior to inserting the string plug into the hole, and the threading member is open on one end to disengage the threaded string plug from the inserted insertion tip during the extraction of the insertion tip from the hole.

19. The tire plug apparatus of claim 14, wherein the motor is further configured to receive electrical power to supply the insertion force and the extraction force.

20. The tire plug apparatus of claim 19, wherein the body is further configured to receive a battery to provide the received electrical power to the motor.
